(19) United States
(12) Patent Application Publication
(10) Pub. No.: US 2011/0202499 A1
(43) Pub. Date: Aug. 18, 2011

(54) Universal Traceability Strategy

(75) Inventor: Laura Lynn Spiers, Jonestown, TX (US)

(73) Assignee: DELL PRODUCTS L.P., Round Rock, TX (US)

(21) Appl. No.: 12/705,138

(22) Filed: Feb. 12, 2010

(51) Int. Cl. G06F 17/30

(52) U.S. Cl. 707/607; 707/E17.005

(57) ABSTRACT

This disclosure provides a system for designing a system in support of one or more business processes including a database, an interface, and a requirements platform. The database may include data associated with a plurality of operational systems for information handling systems that have been deployed. The interface may be configured to receive a request for a system design. The requirements platform may be configured to query the database for information about historical use of information handling systems in support of various business processes, to determine a set of metrics for analyzing a plurality of historical system designs, to apply the set of metrics to the data in the database to identify one or more potential related reports, to analyze the request to determine an appropriate format for the report, and to generate the report.

### TECHNICAL FIELD

The present disclosure relates in general to information handling systems, and more particularly to a universal traceability strategy.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many information technology organizations seek the ability to estimate upcoming work and calculate return on investment before undertaking new projects. Traditional solutions include the investment in the purchase of tool suites and/or the development of processes without much success. These solutions normally require significant use of human resources for system documentation and/or implementation in excess of the value added by the process.

In some cases, information technology organizations may develop processes tailored to a specific implementation for software and/or hardware design. For example, one process may include a requirements analysis to determine whether a given software application or solution will fit with the existing hardware and software currently deployed by the organization. Such tailored processes are unique to the organization that develops them and limited in application to the software and/or hardware design context.

### SUMMARY

In accordance with the teachings of the present disclosure, a system may comprise a database, an interface, and a requirements platform. The database may include data associated with a plurality of operational systems for information handling systems that have been deployed, the data including information about historical use of hardware and software. The interface may be configured to receive a request for a system design, the request including terms defining a part of the content of a report to be delivered. The requirements platform may be coupled to both the database and the interface. The requirements platform may be configured to query the database for information about historical use of hardware and software, to determine a set of metrics for analyzing a plurality of potential solutions, to apply the set of metrics to the data in the database to identify one or more potential designs for the requested system, to analyze the request to determine an appropriate format for the report to be delivered, and to generate the report. The interface may be configured to deliver the report including a validation of at least one potential design for the requested system.

In accordance with the teachings of the present disclosure, a method for generating a strategy for system design may comprise receiving a request for a system, analyzing the request to determine an appropriate format for the report to be delivered, querying a database, determining a set of metrics for analyzing a plurality of potential solutions, applying the set of metrics to the data in the database to identify one or more potential designs for the requested system, generating the report including a validation of at least one potential design for the requested system, and delivering the requested report. The request may include terms defining a part of the content of a report to be delivered. The database may include data associated with a plurality of operational systems for information handling systems that have been deployed. The data may include information about historical use of hardware and software.

In accordance with the teachings of the present disclosure, a program product for generating a strategy for system design may include a computer-readable storage medium and a system design package encoded in the computer-usable storage medium. The system design package may include instructions for receiving a request for a system. The request may include terms defining a part of the content of a report to be delivered. The system design package may include instructions for analyzing the request to determine an appropriate format for the report to be delivered. The system design package may include instructions for querying a database, the database including data associated with a plurality of operational systems for information handling systems that have been deployed, the data including information about historical use of hardware and software. The system design package may include instructions for determining a set of metrics for analyzing a plurality of potential solutions. The system design package may include instructions for applying the set of metrics to the data in the database to identify one or more potential designs for the requested system. The system design package may include instructions for generating the report including a validation of at least one potential design for the requested system. The system design package may include instructions for delivering the requested report.

The teachings of the present disclosure may provide a broad based traceability strategy for designing, implementing, and/or operationalizing business processes, system processes, business policies, and/or system policies. By providing data gathered from multiple organizations, divisions, and/or entities, solutions may be tested and approved without creating a new process for each user. In use, the processes taught by the present disclosure may provide applications in international, public, and commercial environments beyond software and/or hardware design. Providing a centralized database with a broad base of information may allow the implementation of a universal strategy applicable across all process fields.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram illustrating an example method that may be used to implement the teachings of the present disclosure;

FIG. 2 is a block diagram illustrating the layout of an example information handling system in accordance with teachings of the present disclosure;

FIG. 3 is a block diagram illustrating the layout of an example information handling system in accordance with teachings of the present disclosure;

FIG. 4 is a flowchart illustrating an example method for designing a system from the point of view of an end user in accordance with teachings of the present disclosure;

FIG. 5 is a flowchart illustrating an example method for performing activity processing from the point of view of an information handling system in accordance with teachings of the present disclosure;

FIG. 6 is a flowchart illustrating an example method for performing endorsement processing from the point of view of an information handling system in accordance with teachings of the present disclosure; and

FIG. 7 is a flowchart illustrating an example method for performing deliverable design from the point of view of an information handling system in accordance with teachings of the present disclosure.

### DETAILED DESCRIPTION

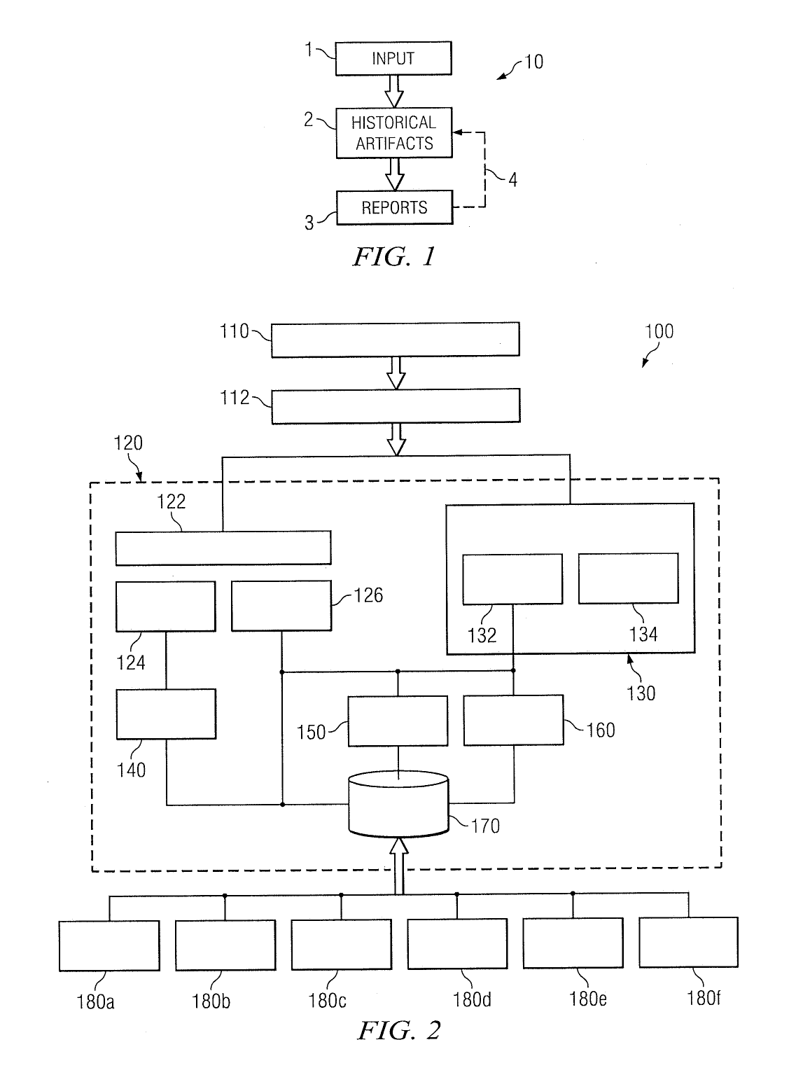

Preferred embodiments and their advantages are best understood by reference to FIGS. 1 through 7, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

FIG. 1 is a block diagram illustrating an example method for generating a strategy for system design 10 that may be used to implement the teachings of the present disclosure. Method 10 may include the steps of gathering input 1, comparing the input to historical artifacts 2, and generating a report 3. Method 10 may also include updating the set of historical artifacts 4 by supplying the report generated at step 3 to the set of artifacts to be compared at step 2.

Gathering input at step 1 may include any form of a request for a system design. As examples, input may include new legislation compliance efforts, customer requests for business processes and/or solutions, and/or new business rules implemented by a specific customer and/or industry.

Comparing the input to historical artifacts at step 2 may include any sort of historical artifact appropriate to the designing a system in response to the request at step 1. As examples, historical artifacts may include test cases, security test reports, audit reviews, compliance reports, impact of change estimates, CCB analysis, hardware/software provisioning results, operational protocols, and/or training manuals. Which historical artifacts are appropriate for comparison may depend at least in part on the nature of the request made at step 1.

Generating a report at step 3 may include reporting the results of the comparison at step 2, and/or generating a new deliverable based on the results of the comparison performed at step 2. For example, a report may include an audit report suitable for submission to an auditing entity and/or a set of one or more metrics suitable for application to an ongoing business process.

Offered as an example, use of method 10 may facilitate compliance with the Sarbanes-Oxley Act (SOX) of 2002. SOX was enacted as a reaction to a number of corporate accounting scandals and created a new agency known as the Public Company Accounting Oversight Board. That board is tasking with overseeing, regulating, inspecting, and disciplining accounting firms in their roles as auditors of public companies. One section of SOX requires management of a company and its external auditor to report on the adequacy of the company's internal controls over financial reporting. This report has been identified as the most costly aspect compliance with the SOX act. The costs include documentation and testing of financial manual and automated controls.

Many companies have already implemented aspects of SOX compliance internally. A centralized, or universal, requirements system with access to thousands of separate implementations may be able to reduce compliance costs by accessing those implementations to create later reporting and compliance procedures. As new processes and compliance demands are regulated, requested, or conceived, a universal requirements system may be able to apply lessons learned in SOX compliance programs, for example, to compliance with later instituted regulatory schemes.

While the above-discussed example may be specific to financial and/or accounting applications, the teachings of the present disclosure may be applied to any area of business processes and/or system design. The information stored in the database of deployed client systems (discussed in relation to FIG. 2) may be applied across business areas and process areas for efficiency gains in the design, development, and deployment of any processes.

As additional examples, the teachings of the present disclosure may include operations audits, IT operational system design, human resources (HR) implementation or hiring and/or training processes, security audits, and/or business impact assessment. Operations audit may include the demonstration impact of policy implementation on various systems in place. IT operational system design may include identifying hardware provisioning, software provisioning, infrastructure needs, client desktop needs, and/or setting up access rights. HR processes may include assessing user skill needs for hiring and/or training. Security audits may include analyzing the potential impact to security of a change in system infrastructure. Business impact assessment may analyze the impact of a change to a business process on the reporting and/or system functions and/or requirements of a system. Use of the teachings of the present disclosure may allow standardization of reporting formats across several areas of a single entity or set of entities. Although an extensive list of applications is identified, persons having ordinary skill in the art will be able to apply these teachings across a wide set of applications and/or business processes.

FIG. 2 is a block diagram illustrating the layout of an example information handling system 100 in accordance with teachings of the present disclosure. Information handling system 100 may include a user interface 110, a requirements platform 120, a database 170, and client systems 180.

User interface 110 may comprise any instrumentality or aggregation of instrumentalities by which a person may interact with information handling system 100 and/or any element associated with the information handling system 100. For example, user interface 110 may permit a person to enter data and/or instructions into information handling system 100 (e.g., via a keyboard, pointing device, and/or other suitable means). User interface 110 may also permit information handling system 100 to communicate data to a person (e.g., by means of a display device). For example, user interface may include presentation layer 112 according to the OSI reference model. The OSI model is an abstract description of a layered communications model which may be used in computer network protocol design. Presentation layer 112 may include software and/or hardware configured to deliver and format information for processing and/or display. For example, presentation layer 112 may convert a EBCDIC-coded text file to an ASCII-coded file for presentation.

Requirements platform 120 may include any system, device, or apparatus operable to interpret and/or execute program instructions and/or process data, and may include, without limitation, a microprocessor, microcontroller, digital signal processor (DSP), application specific integrated circuit (ASIC), or any other digital or analog circuitry configured to interpret data, process data, and/or execute program instructions. In some embodiments, requirements platform 120 may execute program instructions, interpret data, and/or process data stored in a memory and/or another component of information handling system 100 and/or requirements platform 120.

Requirements platform 120 may include a memory and may comprise any system, device, or apparatus operable to retain program instructions or data for a period of time (e.g., computer-readable media). A memory may include random access memory (RAM), electrically erasable programmable read-only memory (EEPROM), a PCMCIA card, flash memory, magnetic storage, opto-magnetic storage, and/or any suitable selection or array of volatile or non-volatile memory that retains data after power to information handling system 100 is turned off.

Requirements platform 120 may include one or more network connections operable to serve as an interface between respective components of information handling system 100. A network connection may enable information handling system 100 and/or any element associated with the information handling system 100 (e.g., the plurality of physical storage resources 118) to communicate using any suitable transmission protocol and/or standard, including without limitation, Fibre Channel, Frame Relay, Asynchronous Transfer Mode (ATM), Internet protocol (IP), other packet-based protocol, small computer system interface (SCSI), Internet SCSI (iSCSI), advanced technology attachment (ATA), serial ATA (SATA), advanced technology attachment packet interface (ATAPI), serial storage architecture (SSA), integrated drive electronics (IDE), and/or any combination thereof.

Database 170 may include a plurality of physical storage resources. For the purposes of this disclosure, a physical storage resource may include any instrumentality or aggregation of instrumentalities that may retain data and/or instructions for a period of time. Physical storage resources may include solid state disks, hard disk drives, magnetic tape libraries, optical disk drives, magneto-optical disk drives, compact disk drives, compact disk arrays, disk array controllers, and/or any computer-readable medium operable to store data.

Client systems 180a-180f may include any resource, component, or device of information handling system 100 in communication with requirements platform 120 that may store data related to system design and/or operational history. For example, client system 180 may include an information handling system deployed at a client, an informational database including historical audit reports generated by a software design entity, and/or any results of business processes and strategies compiled over time.

Once implemented, information handling system 100 may allow a user to request a system design, a report, or other strategy for system design and/or testing. As examples, a user may request a policy audit, a business and systems impact assessment, a security audit, a strategy to provision hardware and/or software, a business process test, a system processing test, to train users, to determine a skill set for new hires and/or promotions, and/or to publish policies and/or procedures. Interface 110 may be configured to allow a predetermined set of requests (e.g., by providing a menu or a list for a user) or may be configured to allow a user to define his or her own request without limitations.

Requirements platform 120 may receive a user request from interface 110. As shown in FIG. 2, the user request may be considered by search engine 122 and/or administration tools 130. For example, search engine 122 may compare the user request against a predetermined set of known activities. As another example, search engine 122 may allow a user to search among historical activities published by requirements platform 120.

As another example, administration tools 130 may include a module configured to define user access and rights 134 and/or a deliverable design module 132. Access and rights module 134 may allow a designated administrator to allow a user to design his or her own report and/or deliverable. As another example, the administrator may be able to allow and/or restrict one or more users from access to any data underlying the application of methods according to the present disclosure.

Deliverable design module 132 may include a software and/or hardware package configured to generate a design for a report to be generated by requirements module 120. For example, deliverable design module 132 may be configured to allow an individual to design a report and/or deliverable in light of a request received from interface 110. Deliverable design module may provide access to a set of templates 150 stored by requirements module 120.

Requirements platform 120 may include software and/or hardware configured to generate a report in response to the request received from interface 110. Some example modules may include scoring and endorsement module 124, deliverable processing module 126, scoring and reporting engine 140, templates 150, and/or universal tracing strategy (UTS) rules engine 160.

For example, scoring and endorsement module 124 may be configured to assess the quality and/or value of a proposed report and/or strategy. Scoring and endorsement module 124 may collaborate with scoring and endorsement engine 140 to apply rules and/or metrics to a proposed report and/or strategy and deliver the results to the user.

Deliverable processing module 126 may be configured to publish, generate, and/or process the content of a proposed report and/or strategy. As examples, deliverable processing module 126 may include word processing applications, spreadsheet applications, web-based publication applications, and/or other numerical and/or text based publication options.

Templates 150 may include a repository of basic reporting and/or strategy skeletons. For example, templates 150 may include a set of word processing templates, one or more report forms, and/or other frameworks that may be useful in the design and/or completion of a report.

UTS rules engine 160 may include a module or engine configured to apply a set of rules to any of the process steps taught in the present disclosure. For example, UTS rules engine may convert legislative requirements and/or statutory reporting requirements to a set of rules that may be applied to a proposed strategy and/or report. As another example, UTS rules engine 160 may apply rules designated by a user and/or a service provider.

Database 170 may be any collection of data related to operations and/or business processes, stored in a memory associated with requirements platform 120. As examples, database 170 may include the operational history of various client systems 180a-180f. As other examples, database 170 may include a record of all strategies and/or reports previously generated by requirements platform 120. In some embodiments, database 170 may receive continuous or periodic updates from client systems 180a-180f. Although six client systems 180 are depicted in FIG. 2, information handling system 100 may include any number of client systems.

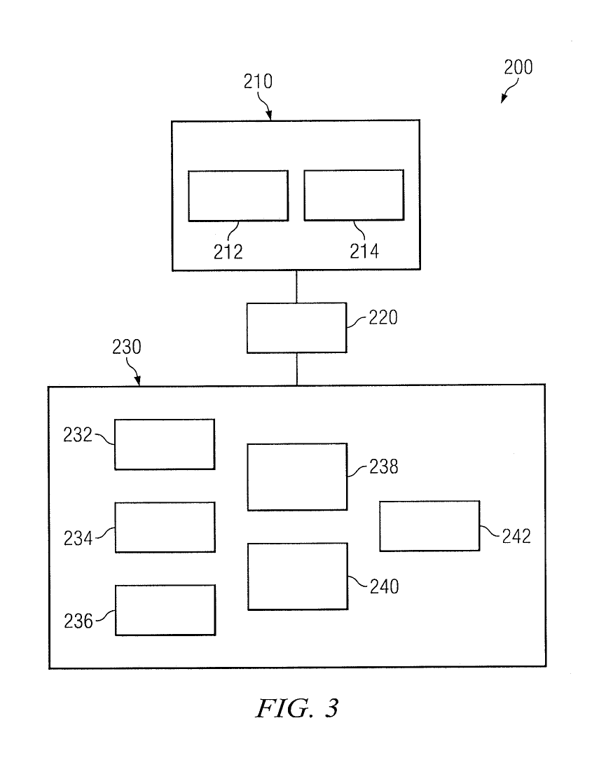

FIG. 3 is a block diagram illustrating the layout of an example information handling system 200 in accordance with teachings of the present disclosure. Information handling system 200 may include IT environment 210, rules management (RM) interface 220, and/or operations requirement platform 230. Each component of information handling system 200 may comprise software and/or hardware configured to communicate with one another and with additional components of information handling system 200. For example, operations requirement platform 230 may include activities portal 242 configured to receive requests for reports and/or publish reports to an end user.

IT environment 210 may include one or more components configured to operate as a database. For example, IT environment 210 may include metadata repository 212 and/or requirements management database (RMDB) 214. IT environment 210 may be configured to store, access, and/or provide data for use by operations requirement platform 230. As an example, metadata repository 212 may include data reflecting one or more operation systems, report designs, and/or strategies. As another example, the data in RMDB 214 may include requirements as well as data used for identifying, eliciting, documenting, analyzing, tracing, prioritizing, and/or agreeing on requirements useful for managing a project, a system design, and/or business processes.

RM interface 220 may provide an avenue of communication between IT environment 210 and operations requirement platform 230. RM interface 220 may include any combination of software and/or hardware configured to access data from IT environment 210, to add data to IT environment 210, and/or to manage the flow of requests and/or data packets between IT environment 210 and operations requirements platform 230.

Operations requirements platform 230 may include any combination of software and/or hardware configured to perform one or more of the following steps: to receive a request for a system design, business process, and/or report, to analyze the request, to determine an appropriate format for the report to be delivered, to query IT environment 210 for information about historical use of software and/or hardware, to determine a set of metrics for analyzing a plurality of potential solutions, to apply the set of metrics to the data in IT environment 210 to identify one or more potential designs for the requested system, and to generate the report, and to deliver the report to the user. In some examples, operations requirements platform 230 may also validate at least one potential design for the requested system.

In the example information handling system 200 shown in FIG. 3, operations requirements platform 230 includes data reporting module 232, deliverable design module 234, RM administrator 236, RM rules engine 238, deliverable processing module 240, and activity portal 242.

Activity portal 242 may provide the interface between an end user and information handling system 200. For example, an end user may request access to common activities performed by a business. Some example requests may include the following options: conduct a policy audit, perform a business and systems impact analysis, perform a business and systems performance and importance assessment, conduct a security audit, provision hardware and/or software, conduct business process testing, conduct system processing testing, train users, determine a skill set for a new hire, and/or publish policies and procedures. As another example, activity portal 242 may provide a publishing capacity to deliver reports and/or results to the end user and/or other recipients.

Data reporting module 232 may be configured to endorse data received from IT environment 210 and/or to endorse reports and/or results generated by the other components of operations requirements platform 230. For example, data reporting module 232 may validate results and/or reports and submit a review request if the results and/or reports cannot be validated based on review rules and/or criteria used by data reporting module 232.

Deliverable design module 234 may be configured to design and/or select the format of a deliverable and/or report to be generated in response to a request received by operations requirements platform 230. Example functions of deliverable design module 234 may include: allowing a user to view and/or change existing activities and/or requests, checking a new request against existing requests, compiling attributes, criteria, output format, and/or confirming target users.

RM administrator 236 may be configured to allow an administrator to restrict access to various modules of operations requirements platform 230. For example, RM administrator may allow an administrator to set user rights, add or remove security protocols and/or safeguards, and/or set load requirements (e.g., manual vs. automatic).

RM rules engine 238 may be configured to apply one or more sets of rules and/or design criteria to potential system designs, report designs, and/or other results generated by operations requirement platform 230. For example, RM rules engine 238 may validate a result by applying universal traceability rules and/or design constraints. As another example, RM rules engine 238 may respond to reporting flags and/or warnings generated by data reporting module 232.

Deliverable processing module 240 may be configured to format a deliverable to be produced by operations requirements platform 230 in response to a received request. For example, deliverable processing module 240 may format requirements by a predetermined hierarchy, and/or may apply new rules based on the data included in the received request. As another example, deliverable processing module 240 may format requirements based on attributes based on business process activity rules, publishing constraints, and/or preferences.

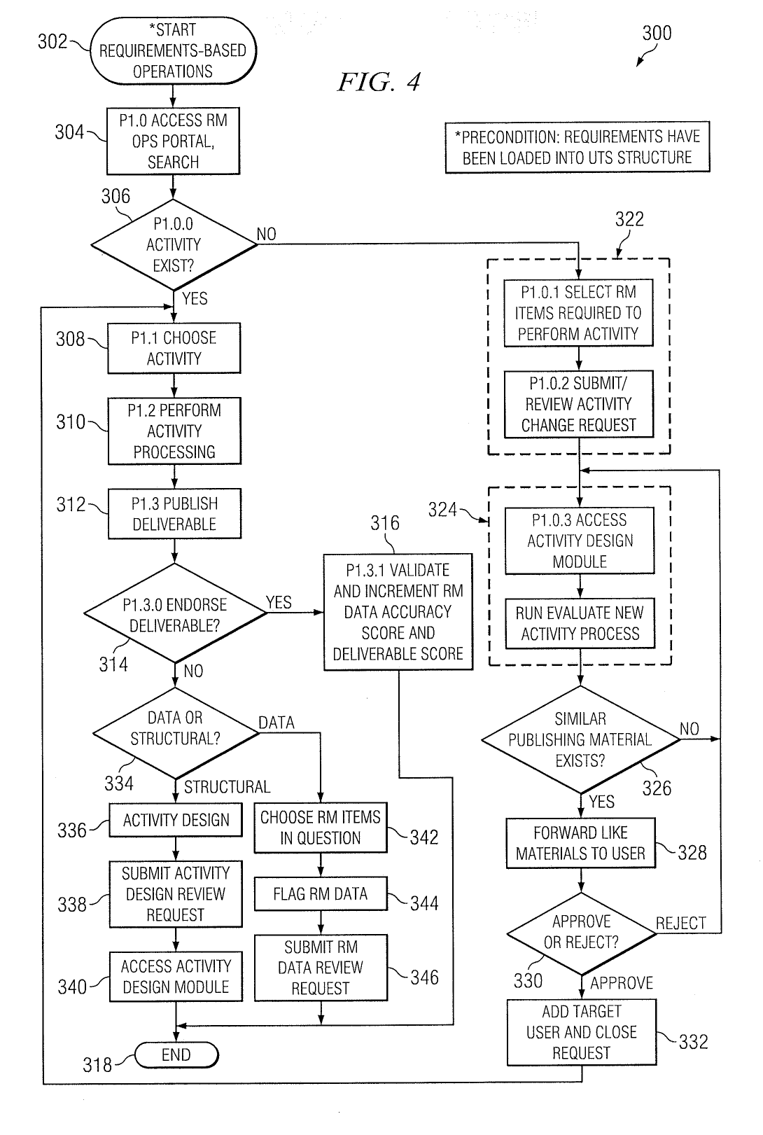

FIG. 4 is a flowchart illustrating an example method 300 for designing a system from the point of view of an end user in accordance with teachings of the present disclosure. Method 300 may be useful in practice with information handling systems 100, 200, and/or other information handling systems designed in accordance with the teachings of the present disclosure. Although the following description of method 300 follows the order of steps shown in FIG. 4, these steps may be performed in any appropriate order and/or combination, including the omission of one or more steps as appropriate.

At step 302, an end-user may submit a request for a report, a system design, and/or other deliverable as discussed above and below. The end-user may submit such a request through an interface. Example interfaces may include a web-based program, a dedicated terminal, interaction with a live representative, and/or any other appropriate means.

At step 304, the request may enter the system through an activity portal, a web portal, and/or any other interface. The request may include a reference to an existing business process, a description of one or more processes to be designed, a characterization of functions to be performed by a system, and/or any other request for a business process design, a software and/or hardware system design, etc.

At step 306, the system determines whether the request corresponds to an existing activity. If yes, method 300 proceeds to step 308. If no, method 300 proceeds to step 322.

At step 308, the system chooses an activity that corresponds to the request. The activity may include applying defined metrics to a new set of data, comparing a proposed solution to a set of ranking criteria, etc.

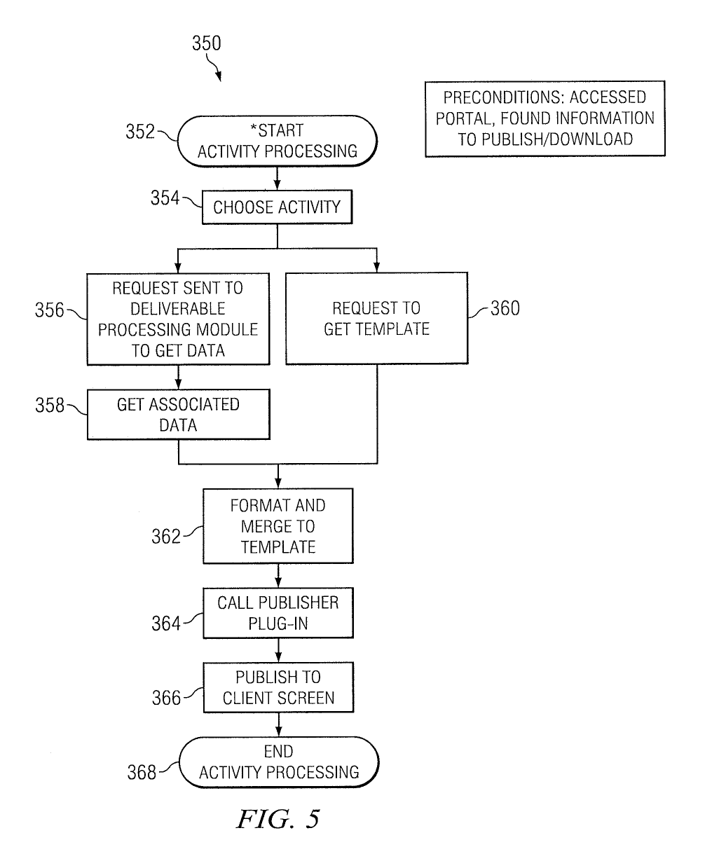

At step 310, the system performs activity processing. Activity processing may include performing the activity identified at step 308. For example, activity processing may include generating a deliverable comprising the solution or response to the request submitted by the end-user. One example method for activity processing is discussed below in reference to FIG. 5.

At step 312, the system publishes the deliverable generated at step 310. Publishing the deliverable may include generating a text file, a graph, and/or other communication including the results of the activity processing.

At step 314, the system tests the deliverable for endorsement. The test for endorsement may be performed by

RM rules engine 238 as discussed above. Endorsing the deliverable may include comparing the contents and/or design of the deliverable against a set of one or more criteria for presentation, format, and/or utility for the end-user. If the deliverable is endorsed, method 300 proceeds to step 316. If not, method 300 proceeds to step 334.

At step 316, the system validates the deliverable and may increment the rules management database, adjust an accuracy score, and/or adjust a deliverable score before proceeding to END at step 318.

If step 306 determined there was no correlated existing activity, method 300 proceeded to step 322. At step 322, the system may select one or more rules management items required to design an activity to respond to the received request. Step 322 may include the activity of an individual and/or the operation of a deliverable design module as discussed above. During step 322, the system may submit and/or review an activity change request from step 322.

At step 324, the system may evaluate the new activity. Step 324 may include accessing deliverable design module 234 and/or other components of operations requirements platform 230 as discussed above. Evaluating the new activity may include testing the proposed new activity against known business constraints, rules imposed by regulatory schemes and/or legislation, etc.

At step 326, the system may determine whether similar material already exists in the database associated with the system. If yes, the system may proceed to step 328 and forward the material for consideration. If no, method 300 may return to step 324 and prepare an alternative activity design.

At step 330, the similar material may be approved or rejected. If approved, method 300 may proceed to step 332. If rejected, method 300 may return to step 324 and prepare an alternative activity design.

At step 332, the system may add the approved material to the activities considered at step 308. In addition, step 332 may include closing an activity change request submitted at step 322.

At step 334, the system may determine why the deliverable was not endorsed at step 314. For example, there may be a structural violation of the rules or criteria in place. If there is a structural problem, method 300 may proceed to step 336. If there is a data problem, method 300 may proceed to step 342.

At step 336, method 300 may perform an activity design. Activity design may include processes similar to those discussed in relation to steps 322-332. For example, step 338 may include submitting an activity request and/or a activity design review request. Step 340 may include accessing an activity design module to perform the requested review.

At step 342, method 300 may including choosing one or more components of data which have been identified at step 314.

At step 344, method 300 may flag the data identified at step 314.

At step 346, method 300 may submit a review request to have the flagged data considered by a user, an administrator, and/or another source.

FIG. 5 is a flowchart illustrating an example method 350 for performing activity processing from the point of view of an information handling system in accordance with teachings of the present disclosure. Method 350 may be useful in practice with information handling systems 100, 200, and/or other information handling systems designed in accordance with the teachings of the present disclosure. One example use of method 350 is at step 310 of method 300. Although the following description of method 350 follows the order of steps shown in FIG. 5, these steps may be performed in any appropriate order and/or combination, including the omission of one or more steps as appropriate.

Method 350 starts at step 352.

At step 354, the activity processing module may choose an activity. Examples include an end-user choosing an activity and/or an information handling system applying a set of instructions to select an activity.

At step 356, the system may send a request to the deliverable processing module. The request may include a request for data related to the activity chosen.

At step 358, the system may gather the associated data.

At step 360, the system may send a request to get a template from templates 150.

At step 362, method 350 may include formatting the gathered data from step 358 into the template requested at step 360.

At step 364, method 350 may include activating a publishing program and/or plug-in. Step 364 may include converting the results of step 362 into a format useful for an end-user and/or client.

At step 366, the system may publish an activity using an interface as described above.

Method 350 ends at step 368.

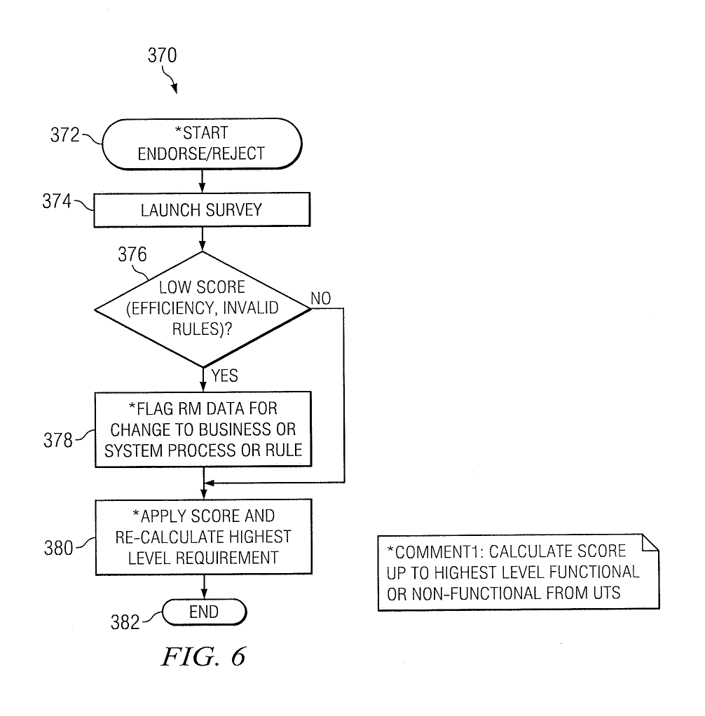

FIG. 6 is a flowchart illustrating an example method 370 for performing activity processing from the point of view of an information handling system in accordance with teachings of the present disclosure. One example use of method 370 may be employed at step 314 of method 300. Method 370 may be useful in practice with information handling systems 100, 200, and/or other information handling systems designed in accordance with the teachings of the present disclosure. Although the following description of method 370 follows the order of steps shown in FIG. 6, these steps may be performed in any appropriate order and/or combination, including the omission of one or more steps as appropriate.

Method 370 starts at step 372. Method 370 may be used to endorse or reject a proposed deliverable.

At step 374, the system may launch the endorsement process. An example endorsement may include a survey and/or another assessment tool.

At step 376, method 370 may determine a score the proposed deliverable based on efficiency, imposed rules, and/or any other criteria. If the score of the proposed deliverable falls below a predetermined threshold, method 370 may proceed to step 378. If the score of the proposed deliverable is above the predetermined threshold, method 370 may proceed to step 380.

At step 378, the system may flag the deliverable for further action. Further action may, by way of example only, include any action to improve the score of the deliverable.

For example, a business process and/or system design may be returned for redesign. As another example, the low score may indicate that the predetermined threshold of step 376 was selected badly, so further action may include checking the applied rules for effectiveness and accuracy. Flagging the deliverable at step 378 may request user action and/or may result in automatic actions by the system.

At step 380, the system may apply the score determined at step 376. For example, applying the score may include updating the database, publishing the score along with the deliverable, recalculating the predetermined score threshold based on the determined score, etc.

Method 370 ends at step 382.

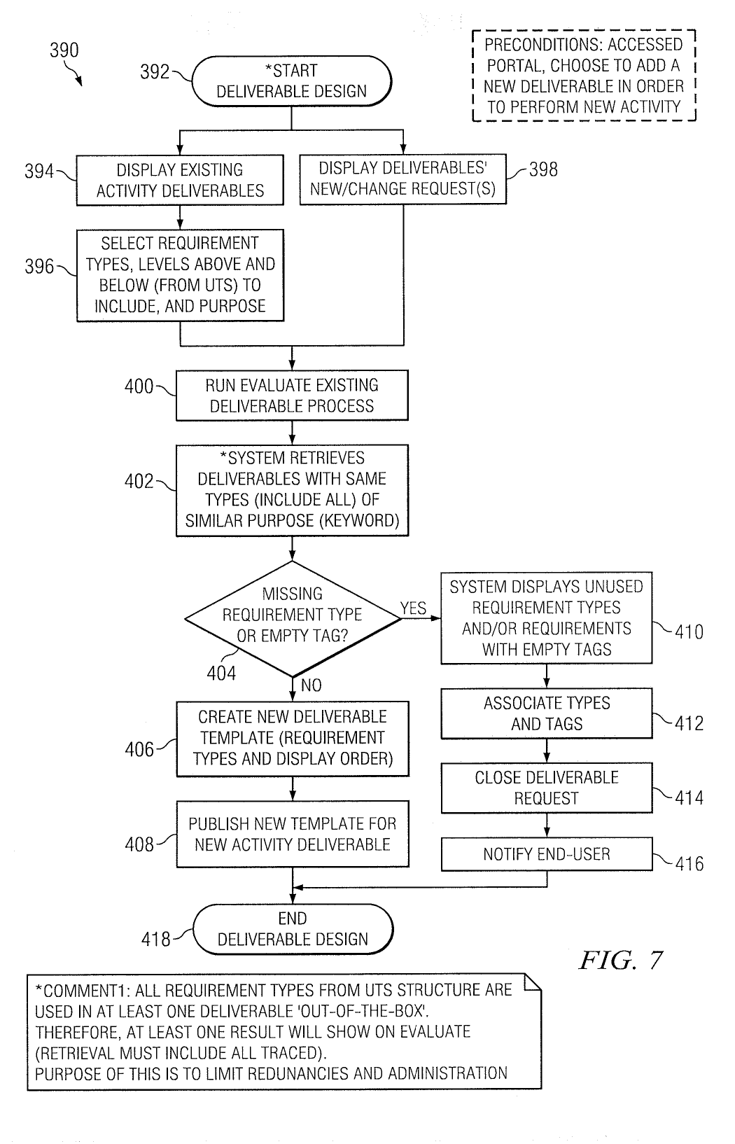

FIG. 7 is a flowchart illustrating an example method 390 for applying endorsement requirements from the point of view of an information handling system in accordance with teachings of the present disclosure. Method 390 may be useful in practice with information handling systems 100, 200, and/or other information handling systems designed in accordance with the teachings of the present disclosure. Although the following description of method 390 follows the order of steps shown in FIG. 7, these steps may be performed in any appropriate order and/or combination, including the omission of one or more steps as appropriate. Method 390 starts at step 392.

At step 394, the system may display existing activity deliverables. Displaying existing activity deliverables may allow a user to select among available deliverables without investing additional resources in the design of a deliverable, a system design, and/or a report. As another example, a user may decide to begin with an existing deliverable, then add and/or delete requirements without generating a new deliverable.

At step 396, the system may allow a user to select requirements for the requested deliverable. The requirements may include universal traceability strategies, business process requirements, compliance with regulatory schemes, etc.

At step 398, the system may display pending requests for new deliverables. The pending requests may include change requests related to existing deliverables and/or requests for deliverables to be created.

At step 400, the system may execute a process to evaluate existing deliverables against the pending requests. Evaluating deliverables may include comparing requirements, assessing constraints, and/or comparing formats and templates to a set of design rules (e.g., universal traceability strategy).

At step 402, the system may identify and/or retrieve deliverables stored in the database based on the evaluation completed in step 400. Identification may include a deliverable type, deliverables with similar purposes, and/or any other relational test.

At step 404, the system may determine whether the identified deliverables have a missing requirement type and/or an empty tag. If yes, method 390 may proceed to step 410. If no, method 390 may proceed to step 406.

At step 406, the system may create a new deliverable template. A template may include a list of requirement types and an order in which the requirements may be displayed.

At step 408, the system may publish a new template for a new activity deliverable.

At step 410, the system may display unused requirement types and/or requirements with empty tags.

At step 412, the system may associate types and tags displayed at step 410.

At step 414, the system may close the request for a deliverable.

At step 416, the system may notify an end-user that the deliverable request has been closed.

Method 390 ends at step 418.

Although the figures and embodiments disclosed herein have been described with respect to information handling systems, it should be understood that various changes, substitutions and alternations can be made herein without departing from the spirit and scope of the disclosure as illustrated by the following claims.

What is claimed is:

1. A system comprising:
a database including data associated with a plurality of operational systems for information handling systems that have been deployed, the data including information about historical use of information handling systems in support of various business processes;
an interface configured to receive a request for a system design, the request including terms defining a part of the content of a report to be delivered; and
a requirements platform coupled to both the database and the interface;
the requirements platform configured to query the database for information about historical use of information handling systems in support of various business processes, to determine a set of metrics for analyzing a plurality of historical system designs, to apply the set of metrics to the data in the database to identify one or more potential related reports, to analyze the request to determine an appropriate format for the report, and to generate the report; and
the interface configured to deliver the report including a validation of at least one potential system design.

2. A system according to claim 1, further comprising a connection between the database and the plurality of operational systems for real-time updates of the data in the database.

3. A system according to claim 1, wherein the set of metrics includes a set of design rules for limiting the plurality of potential solutions.

4. A system according to claim 1, wherein the requirements platform includes a template report format for one or more commonly requested systems.

5. A system according to claim 1, wherein the requirements platform includes a data reporting module configured:
to test the at least one validated potential design for the requested system; and
to submit a review request for any report containing a data inconsistency.

6. A system according to claim 1, wherein the requirements platform includes a deliverable design module configured:
to analyze the request for a system design; and
to compare the request to existing system designs.

7. A system according to claim 1, wherein the requirements platform includes a deliverable processing module configured to generate report formats including a hierarchy of metrics, the hierarchy based at least on business process activity rules and publishing rules.

8. A system according to claim 1, wherein the requirements platform includes an RM rules engine configured to validate the generated report based at least on a set of design rules and reporting flags.

9. A system according to claim 1, wherein the requirements platform includes an administrator module configured to allow an administrator to load requirements, set user rights, and manage security.

10. A method for generating a strategy for system design, the method comprising:
receiving a request for a system design, the request including terms defining a part of the content of a report to be delivered;
analyzing the request to determine an appropriate format for the report to be delivered;
querying a database, the database including data associated with a plurality of operational systems for information handling systems that have been deployed in support of various business processes, the data including information about historical use of hardware and software;
determining a set of metrics for analyzing a plurality of potential solutions;
applying the set of metrics to the data in the database to identify one or more potential designs for the requested system;
generating the report including a validation of at least one potential design for the requested system; and
delivering the requested report.

11. A method according to claim 10, further comprising updating the database with active connections to the plurality of operational systems.

12. A method according to claim 10, further comprising applying a set of design rules to limit the plurality of potential solutions.

13. A method according to claim 10, further comprising considering a set of template report formats for one or more commonly requested systems.

14. A method according to claim 10, further comprising comparing the request to existing system designs.

15. A method according to claim 10, further comprising generating a report format including a hierarchy of metrics, the hierarchy based at least on business process activity rules and publishing rules.

16. A method according to claim 10, further comprising validating at least one of the one or more potential designs based at least on a set of design rules and reporting flags.

17. A program product for generating a strategy for system design, the program product comprising:
a computer-readable storage medium; and
a system design package encoded in the computer-usable storage medium, wherein the system design package includes:
instructions for receiving a request for a system, the request including terms defining a part of the content of a report to be delivered;
instructions for analyzing the request to determine an appropriate format for the report to be delivered;
instructions for querying a database, the database including data associated with a plurality of operational systems for information handling systems that have been deployed, the data including information about historical use of hardware and software;
instructions for determining a set of metrics for analyzing a plurality of potential solutions;
instructions for applying the set of metrics to the data in the database to identify one or more potential designs for the requested system;
instructions for generating the report including a validation of at least one potential design for the requested system; and
instructions for delivering the requested report.

18. A program product according to claim 17, further comprising instructions for updating the database with active connections to the plurality of operational systems.

19. A program product according to claim 17, further comprising instructions for considering a set of template report formats for one or more commonly requested systems.

20. A program product according to claim 17, further comprising instructions for validating at least one of the one or more potential designs based at least on a set of design rules and reporting flags.
